(19) United States
(12) Patent Application Publication
(10) Pub. No.: US 2025/0206922 A1
(43) Pub. Date: Jun. 26, 2025

(54) RUBBER COMPOSITION CONTAINING ADDITIVE AND USE THEREOF

(71) Applicant: SCHILL + SEILACHER STRUKTOL GMBH, Hamburg (DE)

(72) Inventors: Christian GEIDEL, Hamburg (DE); Volker BOERGER, Hamburg (DE)

(21) Appl. No.: 18/849,011

(22) PCT Filed: Mar. 20, 2023
(86) PCT No.: PCT/EP2023/057104

§ 371 Date: Sep. 20, 2024

(30) Foreign Application Priority Data
Mar. 21, 2022 (EP) 22163392.8

(51) Int. Cl. C08L 9/06; B60C 1/00; C08G 65/332; C08K 3/04; C08K 3/22; C08K 3/36; C08K 5/548

(52) U.S. Cl. CPC C08L 9/06; B60C 1/0016; C08G 65/3322; C08K 3/04; C08K 3/36; C08K 5/548; C08K 2003/2296; C08L 2205/025; C08L 2205/06; C08L 2207/322; C08L 2312/02

(57) ABSTRACT

The present invention relates to a rubber composition containing rubber and at least one rubber additive, characterized in that the at least one rubber additive comprises fatty acid esters, which fatty acid ester is produced from at least one C8 to C22 fatty acid and at least one compound selected from C2 to C4 alkoxylate of a polyol, polyethylene glycol, polypropylene glycol and/or copolymer of ethylene oxide and propylene oxide. The present invention further relates to the use of the rubber additive in a rubber composition and to a tire, in which at least one component is at least partially produced from the rubber composition according to the invention, as well as to processes for the production thereof.

### FIELD OF THE INVENTION

The present invention relates to a rubber composition which contains rubber and at least one rubber additive based on a fatty acid ester. The present invention furthermore relates to the use of the rubber additive in a rubber composition, and to a tyre in which at least one component part is at least partially produced from the rubber composition according to the invention, as well as to processes for the production thereof.

### BACKGROUND OF THE INVENTION

In recent years, the trend in the development of tread compounds for all-season and winter tyres has been determined by the improvements in the properties tyre grip (traction) at low temperatures and tyre wear (stiffness). In order to achieve this, the respective rubber compositions contain rubbers with a long chain length, for example. This results in poor processing (high viscosity, lack of green strength) of the rubber compound. In the rubber industry there are a large number of processing aids, but when they are used at least one other property is impaired, such as for example a lower stiffness (=higher tyre wear, poorer handling) or a higher rolling resistance. For this reason, (cold) plasticizers are typically added to the rubber formulation.

This compromise between processing and the performance criteria tyre grip at low temperatures/tyre wear and tyre rolling resistance is no longer accepted in the development of tyre compounds today because safety aspects (shorter braking distances at low temperatures) and the discussions about particulates (tyre wear, microplastics) are arguments for effective marketing and thus have a determining influence on tyre sales.

US 2017/0051134 A1 relates to a tyre rubber composition with improved dispersibility of silicas in a rubber and tyres produced therefrom. The composition comprises rubber compound and glycerol fatty acid monoester as well as silica.

US 2019/0233622 A1 discloses ethoxylated glycerol esterified with fatty acids for use in rubber compositions for tyres with improved processability and wear resistance (see claim 1, paragraphs [0001] to [0003]). The tyre wear is definitively determined by the glass transition temperature of the rubbers (tan delta max. peak, DMA). US 2019/0233622 A1 does not describe an improvement in the rolling resistance of the tyres produced. The rolling resistance is influenced by materials which alter the tan delta at 60° C. Wear and rolling resistance are variables that are independent of each other and a person skilled in the art would not necessarily take an improvement in one of them to mean an improvement in the other.

An object of the present invention is to develop a new additive for winter and all-season tyres which improves the processing properties of the rubber composition which is used for the production of these tyres. At the same time, the other performance properties of the tyres, in particular the rolling resistance and the properties relating to snow grip and grip in dry conditions, as well as the tyre wear, are not to be impaired or even are also to be at least partially improved.

A further object of the invention is to improve the extrusion properties and the condition of the surfaces and edges of extrudates (Garvey die) which are produced from the rubber composition.

### SUMMARY OF THE INVENTION

The object is achieved according to the invention by a rubber composition which contains rubber and at least one rubber additive, characterized in that the at least one rubber additive comprises fatty acid ester, which fatty acid ester is produced from at least one C₈ to C₂₂ fatty acid and at least one compound selected from C₂ to C₄ alkoxylate of a polyol, polyethylene glycol, polypropylene glycol and/or copolymer of ethylene oxide and propylene oxide.

A further aspect of the present invention relates to the use of fatty acid esters of at least one C₈ to C₂₂ fatty acid and at least one compound selected from C₂ to C₄ alkoxylate of a polyol, polyethylene glycol, polypropylene glycol and/or copolymer of ethylene oxide and propylene oxide as rubber additive in a rubber composition for improving the Mooney viscosity and/or extrusion properties of the rubber composition and/or for improving at least one out of wear, wet grip and/or rolling resistance of a tyre produced from the rubber composition.

A further aspect of the present invention relates to a process for producing a tyre, characterized in that one or more component parts of the tyre are produced from a rubber composition as defined herein and the rubber composition is cured.

A further aspect of the present invention relates to a tyre in which at least one component part was produced at least partially from a rubber composition as defined herein, and the tyre is preferably an all-season or winter tyre, wherein the component part is in particular a tread.

Preferred embodiments are the subject-matter of the dependent claims. Embodiments of the inventions comprise the constituents listed in the following and can in particular consist of them.

### BRIEF DESCRIPTION OF THE FIGURES

FIGS. 1a-d show different extrudates (after 24 h and after one week, at 60 min⁻¹ and 15 min⁻¹), which were produced from rubber compositions A and B as described in Example 3 (FIG. 1a: after 24 h at 15 min⁻¹; FIG. 1b: after 24 h at 60 min⁻¹; FIG. 1c: after one week at 15 min⁻¹; Figure id: after one week at 60 min⁻¹).

FIGS. 2a-b show different extrudates after 24 h (at 60 min⁻¹ and 15 min⁻¹), which were produced from rubber compositions C and D as described in Example 4 (FIG. 2a: after 24 h at 15 min⁻¹; FIG. 2b: after 24 h at 60 min⁻¹).

FIGS. 3a-d show different extrudates (after 24 h and after one week, at 60 min⁻¹ and 15 min⁻¹), which were produced from rubber compositions E and F as described in Example 5 (FIG. 3a: after 24 h at 15 min⁻¹; FIG. 3b: after 24 h at 60 min⁻¹; FIG. 3c: after one week at 15 min⁻¹; FIG. 3d: after one week at 60 min⁻¹).

FIGS. 4a-b show different extrudates (at 15 min⁻¹ and 60 min⁻¹), which were produced from rubber compositions G to J as described in Example 6 (FIG. 4a: after 24 h at 15 min⁻¹; FIG. 4b: after 24 h at 60 min⁻¹).

FIG. 5 shows the progression of the material pressure of rubber compositions G to J from Example 6 at different shear rates.

### DETAILED DESCRIPTION OF THE INVENTION

The inventors have surprisingly found that fatty acid esters which are produced from at least one C₈ to C₂₂ fatty acid (fatty acid component, as defined in more detail below) and at least one compound selected from C₂ to C₄ alkoxylate of a polyol, polyethylene glycol, polypropylene glycol and/or copolymer of ethylene oxide and propylene oxide (polyol component, as defined in more detail below) have positive properties in a rubber composition.

The constituents of the rubber composition according to the invention are described in more detail in the following. All statements also apply to the tyre according to the invention, in which at least one component part at least partially consists of the rubber composition according to the invention, the production thereof and the use according to the invention of the fatty acid esters defined herein.

The specification phr (parts per hundred parts of rubber by weight) used in this document is the quantity specification for compound formulations that is usual in the rubber industry. The proportioning of the parts by weight of the individual substances in this document is based on 100 parts by weight of the total mass of all high-molecular-weight and consequently solid rubbers present in the compound.

### Polyol Component

The fatty acid ester according to the invention is produced from at least one compound selected from C₂ to C₄ alkoxylate of a polyol, polyethylene glycol, polypropylene glycol and/or copolymer of ethylene oxide and propylene oxide (polyol component), which has been esterified with a C₈ to C₂₂ fatty acid.

In an embodiment, the polyol component has from 2 to 8 hydroxyl groups, such as from 2 to 6 hydroxyl groups. The polyol component preferably has between 2 and 4 hydroxyl groups. In a particularly preferred embodiment, the polyol component used to produce the fatty acid ester has 2 or 3 hydroxyl groups.

In a preferred embodiment, the polyol component has no aromatic groups.

In a preferred embodiment, the polyol component according to the invention consists only of carbon, hydrogen and oxygen.

In an embodiment, the fatty acid ester is produced from C₈ to C₂₂ fatty acid and at least one polyether such as polyethylene glycol (PEG), polypropylene glycol (PPG) and/or copolymer of ethylene oxide and propylene oxide. The copolymers of ethylene oxide and propylene oxide can be statistical copolymers or block copolymers. It is known to a person skilled in the art that polyethers having higher molar masses are polymolecular, i.e. consist of distributions of macromolecules having different molar masses. According to the invention, polyethylene glycols, polypropylene glycols and/or copolymers of ethylene oxide and propylene oxide having an average molecular weight in the range of from approximately 200 to 1500 g/mol can be used, e.g. from 200 to 800 g/mol, such as approximately 400 g/mol, can be used to produce the fatty acid ester.

In an embodiment, the fatty acid ester according to the invention is produced from polyethylene glycol (PEG), polypropylene glycol (PPG) and/or copolymer of ethylene oxide and propylene oxide, which has been esterified with a C₈ to C₂₂ fatty acid.

In an embodiment, the fatty acid ester according to the invention is produced from polyethylene glycol or polypropylene glycol.

In an embodiment, the fatty acid ester is produced from at least one polyethylene glycol or polypropylene glycol having a molecular weight of from 200 to 800 g/mol, in particular from 400 g/mol to 600 g/mol.

In an embodiment, the fatty acid ester is produced from at least one polyethylene glycol having a molecular weight of from 200 (PEG 200) to 800 g/mol (PEG 800), such as from 400 to 600 g/mol, in particular of 400 g/mol (PEG 400).

In a further embodiment, the fatty acid ester is produced from at least one polypropylene glycol having a molecular weight of from 200 to 800 g/mol, such as from 400 to 600 g/mol, in particular of 600 g/mol.

In an embodiment, the fatty acid ester is produced from at least one statistical copolymer of ethylene oxide and propylene oxide having a molecular weight of from 200 to 800 g/mol, such as from 400 to 600 g/mol, in particular of 400 g/mol. In a preferred embodiment, the statistical copolymer of ethylene oxide and propylene oxide has an ethylene oxide group content of from 10 to 30 wt.-%.

In a further embodiment, the fatty acid ester is produced from at least one block copolymer of ethylene oxide and propylene oxide having a molecular weight of from 50 to 4500 g/mol, such as from 200 to 3000 and in particular from 500 to 2500 g/mol. According to a preferred embodiment, the ethylene oxide/propylene oxide block copolymer has an ethylene oxide group content of from 10 to 80 wt.-%, such as from 10 to 55 wt.-%. The block copolymers can be constructed by polyoxyethylene groups being located in the middle of the polypropylene glycol molecule and at both ends thereof.

The ethylene oxide/propylene oxide block copolymers to be used according to the invention are compounds customary in the trade. They can be produced by reacting polypropylene glycol with ethylene oxide. Examples of ethylene oxide/propylene oxide block copolymers are the Pluronic PE polymers from BASF SE, such as Pluronic PE 3100, Pluronic PE 3500, Pluronic PE 4300, Pluronic PE 6100, Pluronic PE 6120, Pluronic PE 6200, Pluronic PE 6400, Pluronic PE 6800, Pluronic PE 8100, Pluronic PE 9200, Pluronic PE 9400, Pluronic PE 10100, Pluronic PE 10300, Pluronic PE 10400 and Pluronic PE 10500. In a further embodiment, the fatty acid ester is produced from at least one C₂ to C₄ alkoxylate of a polyol. By polyols is meant those substances which have at least two free hydroxyl groups. The hydrocarbon moiety of the polyol is a group which contains carbon and hydrogen, wherein at least two carbon atoms are bonded to one hydroxyl group. It can be straight-chain or branched, in particular straight-chain, and can where appropriate be interrupted by a heteroatom.

A C₂ to C₄ alkoxylate of a polyol is a polyol which has been reacted with a C₂ to C₄ alkylene oxide, wherein several reactions can take place one after another on a hydroxyl group of the polyol. Examples of C₂ to C₄ alkylene oxides are ethylene oxide, propylene oxide and 1-butene oxide. The reaction of the polyols with the C₂ to C₄ alkylene oxide is effected using established processes.

Mixed C₂ to C₄ alkoxylates can also be used, in which a polyol is reacted using a mixture of C₂ to C₄ alkylene oxides (mixture of ethylene oxide and propylene oxide and/or 1-butylene oxide).

In a preferred embodiment, the fatty acid ester is produced from at least one polyol alkoxylate with up to 10, such as from 5 to 10, e.g. 7, alkylene oxide units.

The C₂ to C₄ alkoxylate of a polyol can have an average molecular weight in the range of from approximately 200 to 1500 g/mol, such as from approximately 200 to 800 g/mol, in particular from 300 to 500 g/mol.

In an embodiment, the C₂ to C₄ alkoxylate of a polyol has from 2 to 8 hydroxyl groups, such as from 2 to 6 hydroxyl groups. In a preferred embodiment, the C₂ to C₄ alkoxylate of a polyol used to produce the fatty acid ester has between 2 and 4 hydroxyl groups, such as 2 or 3 hydroxyl groups.

In a preferred embodiment, the fatty acid ester is produced from at least one polyol ethoxylate with up to 10, such as from 5 to 10, e.g. 7, ethylene oxide units (EO units).

In a further preferred embodiment, the fatty acid ester is produced from at least one polyol propoxylate with up to 10, such as from 5 to 10, e.g. 7, propylene oxide units (PO units).

The polyol ethoxylate or polyol propoxylate preferably has between 2 and 4 hydroxyl groups.

The polyol of the C₂ to C₄ alkoxylate can be a C₂ to C₁₅ polyol. This means that the polyol has from 2 to 15 carbon atoms. C₂ to C₁₀ polyol and in particular C₂ to C₆ polyol is preferably used as C₂ to C₁₅ polyol component of the alkoxylate. The polyols preferably have from 2 to 8 hydroxyl groups, such as from 2 to 8 and in particular from 2 to 4 hydroxyl groups, such as 2 or 3 hydroxyl groups.

Examples of polyols which can be reacted with a C₂ to C₄ alkylene oxide are ethylene glycol, propylene glycol, diethylene glycol, triethylene glycol, tetraethylene glycol, 1,3-propanediol, glycerol, pentaerythritol, dipentaerythritol, tripentaerythritol, trimethylolethane, trimethylolpropane and mixtures thereof. The polyol of the C₂ to C₄ alkoxylate is preferably selected from the group consisting of ethylene glycol, propylene glycol, diethylene glycol, triethylene glycol, tetraethylene glycol, glycerol and mixtures thereof and is in particular glycerol.

Sugar alcohols such as for example sorbitol, maltitol, mannitol, xylitol and mixtures thereof can also be used as polyols which can be reacted with a C₂ to C₄ alkylene oxide. This has the further advantage that the thus-produced fatty acid esters can be produced more sustainably.

In a preferred embodiment, the polyol component of the fatty acid ester is a substance from the group consisting of polyethylene glycol, polypropylene glycol, ethoxylated glycerol, ethoxylated trimethylolpropane, ethoxylated pentaerythritol, ethoxylated sorbitol and/or mixtures thereof.

In a particularly preferred embodiment, the fatty acid ester is produced from C₈ to C₂₂ fatty acid and ethoxylated glycerol, which in particular has up to 10, such as from 5 to 10, e.g. 7, ethylene oxide units. Such a glycerol according to the invention is commercially available, for example as Aduxol-Gly-07 from Schärer & Schläpfer.

In an embodiment, only one polyol component is used to produce the fatty acid ester (however, this includes those higher-molecular-weight alcohols which have a certain molecular weight distribution, such as PEG 400).

In a further embodiment, at least two different polyol components are used to produce the fatty acid ester. Thus, a mixture of PEG, PPG and/or PEG-PPG copolymer can be used e.g. to produce the fatty acid ester.

### Fatty Acid Component

The fatty acid component according to the invention is based on C₈ to C₂₂ fatty acids. This means that the fatty acids have from 8 to 22 carbon atoms. It should be noted that by fatty acids is usually meant aliphatic saturated and unsaturated carboxylic acids with an almost exclusively unbranched carbon chain (see e.g. Römpp Chemie Lexikon, 9th edition 1990, volume 2, p. 1343). According to the invention, by “fatty acids” is also meant those acids which have degrees of unsaturation. Branching or hetero atoms can also be present as long as this does not significantly impair the aliphatic nature of the acids.

The fatty acid component according to the invention is thus based on at least one saturated or unsaturated, branched or unbranched (=linear) C₈ to C₂₂ fatty acid.

In an embodiment of the invention, the fatty acid component according to the invention consists of a mixture of different fatty acids. The fatty acid component can comprise at least two, such as at least three, four or five, different C₈ to C₂₂ fatty acids.

Typical examples of fatty acids which can be used as fatty acid component in the present invention are octanoic acid, pelargonic acid, capric acid, undecanoic acid, lauric acid, tridecanoic acid, myristic acid, pentadecanoic acid, palmitic acid, palmitoleic acid, heptadecanoic acid, stearic acid, oleic acid, elaidic acid, vaccenic acid, petroselinic acid, linoleic acid, linolenic acid, ricinoleic acid, 12-hydroxystearic acid, arachidic acid, gadoleic acid, gondoic acid, behenic acid, cetoleic acid and erucic acid.

In a preferred embodiment, the fatty acid component according to the invention consists only of carbon, hydrogen and oxygen.

The fatty acid component according to the invention can comprise at least one saturated or unsaturated, branched or unbranched (=linear) C₁₀ to C₂₂ fatty acid.

The fatty acid component according to the invention preferably comprises at least one C₁₂ to C₂₂ fatty acid, in particular a mono- or polyunsaturated, branched or unbranched (=linear) C₁₆ to C₂₀ fatty acid or mixtures thereof.

In a preferred embodiment, the fatty acid component according to the invention comprises at least one monounsaturated or doubly unsaturated C₁₆ to C₂₀ fatty acid. A doubly unsaturated fatty acid is a fatty acid in which the carbon chain has two double bonds.

In a particularly preferred embodiment, the fatty acid component according to the invention comprises at least one monounsaturated C₁₆ to C₂₀ fatty acid and at least one doubly unsaturated C₁₆ to C₂₀ fatty acid.

In a further particularly preferred embodiment, the fatty acid component according to the invention comprises at least one monounsaturated C₁₆ to C₂₀ fatty acid, at least one doubly unsaturated C₁₆ to C₂₀ fatty acid and at least one triply unsaturated C₁₆ to C₂₀ fatty acid.

In a preferred embodiment, the fatty acid component according to the invention comprises at least one Cis fatty acid, in particular a C_{18:1} fatty acid, such as oleic acid, and/or a C_{18:2} fatty acid. A C_{18:1} fatty acid is a fatty acid with 18 carbon atoms in which the carbon chain has one double bond. A C_{18:2} fatty acid is a fatty acid with 18 carbon atoms in which the carbon chain has two double bonds.

In a preferred embodiment, the fatty acid component according to the invention comprises at least one C_{18:1} fatty acid as well as at least one C_{18:2} fatty acid.

In a further preferred embodiment, the fatty acid component according to the invention comprises at least one C_{18:1} fatty acid, at least one C_{18:2} fatty acid and at least one C_{18:3} fatty acid.

It is known to persons skilled in the art that commercial products used to produce fatty acid esters generally contain mixtures of fatty acids. Moreover, the fatty acids can also be present as technical fractions, such as accumulate during the high-pressure splitting or saponification of natural fats and oils, for example palm oil, palm kernel oil, coconut oil, olive oil, soybean oil, sunflower oil, rapeseed oil or tallow.

In an embodiment, the fatty acid ester according to the invention is produced from a mixture of fatty acids which comprises at least 50 wt.-%, such as at least 75 wt.-%, in particular at least 90 wt.-%, C₈ to C₂₂ fatty acids.

In an embodiment, the fatty acid ester according to the invention is produced from a mixture of fatty acids which comprises at least 50 wt.-%, such as at least 75 wt.-%, in particular at least 90 wt.-%, C₁₂ to C₂₀ fatty acids.

In an embodiment, the fatty acid ester according to the invention is produced from a mixture of fatty acids which comprises at least 50 wt.-%, such as at least 75 wt.-%, in particular at least 90 wt.-%, C₁₆ to C₂₀ fatty acids. The mixture of fatty acids preferably comprises from 50 to 100 wt.-%, such as from 75 to 100 wt.-%, in particular from 90 to 100 wt.-%, C₁₆ to C₂₀ fatty acids.

In an embodiment, the fatty acid ester according to the invention is produced from a mixture of fatty acids which comprises at least 50 wt.-%, such as at least 65 wt.-%, in particular at least 75 wt.-%, saturated or mono- or polyunsaturated Cis fatty acids.

In an embodiment, the fatty acid ester according to the invention is produced from a mixture of fatty acids which comprises from 50 to 95 wt.-%, such as from 65 to 90 wt.-%, in particular from 70 to 85 wt.-%, saturated or mono- or polyunsaturated Cis fatty acids.

The mixture of fatty acids used for the production preferably contains at least 1 wt.-% saturated Cis fatty acid, 10 wt.-% C_{18:1} fatty acid and/or at least 5 wt.-% C_{18:2} fatty acid.

In an embodiment, the mixture of fatty acids comprises at least 50 wt.-%, such as at least 65 wt.-%, in particular at least 70 wt.-%, C_{18:1} fatty acid, in particular oleic acid.

In an embodiment, the mixture of fatty acids comprises from 50 to 90 wt.-%, such as from 65 to 85 wt.-%, in particular from 70 to 80 wt.-%, C_{18:1} fatty acid, in particular oleic acid.

In an embodiment, the mixture of fatty acids comprises from 0.1 to 30 wt.-%, such as from 1 to 15 wt.-%, in particular from 5 to 12 wt.-%, C_{18:2} fatty acid, in particular linoleic acid.

In a preferred embodiment, the mixture of fatty acids comprises from 65 to 85 wt.-% C_{18:1} fatty acid and from 1 to 15 wt.-% C_{18:2} fatty acid.

In a further embodiment, the mixture of fatty acids comprises at least 5 wt.-%, such as at least 10 wt.-%, in particular at least 15 wt.-%, C_{18:1} fatty acid, in particular oleic acid.

The mixture of fatty acids can comprise from 5 to 50 wt.-%, such as from 10 to 40 wt.-%, in particular from 15 to 35 wt.-%, C_{18:1} fatty acid, in particular oleic acid.

The mixture of fatty acids can comprise from 10 to 90 wt.-%, such as from 25 to 75 wt.-%, in particular from 40 to 65 wt.-%, C_{18:2} fatty acid, in particular linoleic acid.

In a preferred embodiment, the mixture of fatty acids comprises from 10 to 40 wt.-% C_{18:1} fatty acid and from 25 to 75 wt.-% C_{18:2} fatty acid, such as from 15 to 35 wt.-% C_{18:1} fatty acid and from 40 to 65 wt.-% C_{18:2} fatty acid.

The mixture of fatty acids can furthermore comprise from 0.1 to 30 wt.-%, such as from 1 to 20 wt.-%, in particular from 2 to 15 wt.-%, C₁83 fatty acid.

In a particularly preferred embodiment, the mixture of fatty acids comprises from 10 to 40 wt.-% C_{18:1} fatty acid, from 25 to 75 wt.-% C_{18:2} fatty acid and from 1 to 20 wt.-% C₁83 fatty acid. In particular, the mixture of fatty acids comprises from 15 to 35 wt.-% C_{18:1} fatty acid and from 40 to 65 wt.-% C_{18:2} fatty acid and from 2 to 15 wt.-% C_{18:3} fatty acid.

The acid value of the fatty acid used or of the fatty acid mixture used is preferably from 100 to 300 mg KOH/g, in particular from 150 to 250 mg KOH/g. The measurement of the acid value is effected using DIN EN ISO 2114. The saponification value of the fatty acid used or of the fatty acid mixture used is preferably from 100 to 300 mg KOH/g, in particular from 150 to 250 mg KOH/g. The saponification value indicates the quantity of potassium hydroxide in mg which is required to saponify 1 g of the sample to be tested. The measurement of the saponification value is effected using DIN EN ISO 3681.

The iodine value of the fatty acid used or of the fatty acid mixture used is preferably from 10 to 200 g iodine/100 g, in particular from 50 to 150 g iodine/100 g. The iodine value indicates the degree of unsaturation of the sample. The measurement of the iodine value is effected using DIN EN ISO 3961 2018-1.

### Fatty Acid Ester

The esterification of the polyols with the fatty acids can be carried out in a known manner. Hypophosphorous acid, methanesulfonic acid, butanesulfonic acid, p-toluenesulfonic acid, naphthalenesulfonic acid, alkylbenzenesulfonic acid, sulfosuccinic acid and/or mixtures thereof can be used as acid catalysts here for example. It is further recommended to carry out the esterification at increased temperature, for example at 140 to 250° C., preferably at 180 to 240° C. In a preferred embodiment, the fatty acid ester is produced by heating in hypophosphorous acid.

As described above, the fatty acid ester can be produced from a mixture of different fatty acids and/or polyols.

In an embodiment, the fatty acid ester according to the invention consists only of carbon, hydrogen and oxygen.

In an embodiment, the fatty acid ester according to the invention is produced from at least one C₂ to C₄ alkoxylate of a C₂ to C₆ polyol and at least one C₁₂ to C₂₂ fatty acid, preferably at least one unsaturated C₁₆ to C₂₀ fatty acid.

The fatty acid ester is preferably a partial ester (i.e. not all —OH groups of the polyol from which the ester is formed are esterified) and in particular at least 40 wt.-% of it, such as at least 70 wt.-%, based on the total mass of partial and full esters, is a fatty acid monoester of a C₈ to C₂₂ fatty acid or of a mixture thereof.

In an embodiment, the fatty acid ester according to the invention consists substantially of fatty acid monoester.

In an embodiment, the fatty acid ester according to the invention is a fatty acid monoester of C₂ to C₄ alkoxylate of a C₂ to C₆ polyol and at least one C₁₆ to C₂₀ fatty acid, preferably of an unsaturated C₁₆ to C₂₀ fatty acid.

In a further embodiment, the fatty acid ester according to the invention is a fatty acid monoester of polyethylene glycol and at least one C₁₂ to C₂₂ fatty acid, preferably of at least one unsaturated C₁₆ to C₂₀ fatty acid.

In a further embodiment, the fatty acid ester according to the invention is a fatty acid monoester of polypropylene glycol and at least one C₁₂ to C₂₂ fatty acid, preferably of at least one unsaturated C₁₆ to C₂₀ fatty acid.

In a further embodiment, the fatty acid ester according to the invention is a fatty acid monoester of copolymer of ethylene oxide and propylene oxide and at least one C₁₂ to C₂₂ fatty acid, preferably of at least one unsaturated C₁₆ to C₂₀ fatty acid. The copolymer of ethylene oxide and propylene oxide can be a statistical copolymer or block copolymer.

In an embodiment, the fatty acid ester according to the invention is a mixture of fatty acid monoesters of polyethylene glycol or polypropylene glycol, wherein the mixture of fatty acids used for the production comprises at least 50 wt.-% C₁₆ to C₂₀ fatty acids, preferably at least 50 wt.-% saturated or (poly)unsaturated Cis fatty acid. The mixture of fatty acids used for the production can comprise from 50 to 95 wt.-%, such as from 65 to 90 wt.-%, in particular from 70 to 85 wt.-%, saturated or (poly)unsaturated Cis fatty acids. The mixture preferably comprises at least 10 wt.-% C_{18:1} fatty acid and/or at least 5 wt.-% C_{18:2} fatty acid.

In a preferred embodiment, the fatty acid ester according to the invention is a mixture of fatty acid monoesters of polyethylene glycol or polypropylene glycol, wherein the mixture of fatty acids used for the production comprises from 65 to 85 wt.-% C_{18:1} fatty acid and/or from 1 to 15 wt.-% C_{18:2} fatty acid.

In a further preferred embodiment, the fatty acid ester according to the invention is a mixture of fatty acid monoesters of polyethylene glycol or polypropylene glycol, wherein the mixture of fatty acids used for the production comprises from 10 to 40 wt.-% C_{18:1} fatty acid and/or from 25 to 75 wt.-% C_{18:2} fatty acid and/or from 1 to 20 wt.-% C_{18:3} fatty acid. In particular, the mixture of fatty acids comprises from 15 to 35 wt.-% C_{18:1} fatty acid and from 40 to 65 wt.-% C_{18:2} fatty acid and from 2 to 15 wt.-% C_{18:3} fatty acid.

In an embodiment, the fatty acid ester according to the invention is an ester of polyol ethoxylate or polyol propoxylate and a C₈ to C₂₂ fatty acid ester mixture, preferably a C₁₂ to C₂₂ fatty acid ester mixture.

In an embodiment, the fatty acid ester according to the invention is an ester of ethoxylated glycerol or trimethylolpropane, which has up to 10, such as from 5 to 10, ethylene oxide units, and a fatty acid ester mixture, wherein the mixture of fatty acids used for the production comprises at least 50 wt.-% C₁₆ to C₂₀ fatty acids, preferably from 50 to 95 wt.-% saturated or unsaturated Cis fatty acid.

In a preferred embodiment, the fatty acid ester according to the invention is an ester of ethoxylated glycerol or ethoxylated trimethylolpropane, which has up to 10, such as from 5 to 10, ethylene oxide units, and a fatty acid ester mixture, wherein the mixture of fatty acids used for the production comprises from 65 to 85 wt.-% C_{18:1} fatty acid and/or from 1 to 15 wt.-% C_{18:2} fatty acid.

In a further preferred embodiment, the fatty acid ester according to the invention is an ester of ethoxylated glycerol or ethoxylated trimethylolpropane, which has up to 10, such as from 5 to 10, ethylene oxide units, and a fatty acid ester mixture, wherein the mixture of fatty acids used for the production comprises from 10 to 40 wt.-% C_{18:1} fatty acid and/or from 25 to 75 wt.-% C_{18:2} fatty acid and/or from 1 to 20 wt.-% C_{18:3} fatty acid.

In a preferred embodiment, the fatty acid ester according to the invention is a monoester of ethoxylated glycerol or ethoxylated trimethylolpropane, which has from 5 to 10 ethylene oxide units, and a fatty acid ester mixture, wherein the mixture of fatty acids used for the production preferably comprises at least 50 wt.-% saturated or unsaturated Cis fatty acid, in particular from 65 to 85 wt.-% C_{18:1} fatty acid and/or from 1 to 15 wt.-% C_{18:2} fatty acid.

In a further preferred embodiment, the fatty acid ester according to the invention is a monoester of ethoxylated glycerol or ethoxylated trimethylolpropane, which has up to 10, such as from 5 to 10, ethylene oxide units, and a fatty acid ester mixture, wherein the mixture of fatty acids used for the production comprises from 10 to 40 wt.-% C_{18:1} fatty acid and/or from 25 to 75 wt.-% C_{18:2} fatty acid and/or from 1 to 20 wt.-% C_{18:3} fatty acid.

In an embodiment, the fatty acid ester has an acid value (AV) of from 0 to 10 mg KOH/g, such as from 2 to 8 mg KOH/g. The measurement of the acid value can be effected using DIN EN ISO 2114.

In an embodiment, the fatty acid ester has a hydroxyl value (HV) of from 5 to 200 mg KOH/g, such as from 100 to 190 mg KOH/g and from 120 to 180 mg KOH/g. The hydroxyl value is the quantity of potassium hydroxide (KOH) in milligrams (mg) which corresponds to the hydroxyl groups which are acetylated in 1 gram of the tested product under defined test conditions. The measurement of the hydroxyl value can be determined using DIN EN ISO 4629-1:2016-12.

In an embodiment, the fatty acid ester has a pour point of from 5 to −50° C., such as from 0 to −40° C. and from −10 to −30° C. The pour point is the lowest temperature at which the oil still just flows when it is cooled under defined conditions. The measurement of the pour point can be effected using DIN ISO 3016.

In an embodiment, the fatty acid ester has a dynamic viscosity of from 50 to 1000 mPa-s, such as from 70 to 700 mPa-s and from 100 to 400 mPa-s. The dynamic viscosity is defined as the quotient of the shear stress and the velocity gradient. The measurement of the dynamic viscosity can be effected using DIN ISO 3219. For this, a viscometer (e.g. a Roto Visko 1 viscometer from Haake) or a rheometer (e.g. Modular Compact 302 from Anton Paar) can be used.

### Rubber Additive

The rubber composition according to the invention contains at least one rubber additive which comprises fatty acid ester.

In an embodiment, the rubber additive can consist of the fatty acid ester. Alternatively, the rubber additive contains at least 50 wt.-%, preferably at least 70 wt.-%, in particular at least 90 wt.-%, fatty acid ester.

In addition to the fatty acid ester, the rubber additive can also have yet further constituents. In a preferred embodiment, the rubber additive contains fatty acid esters and/or fatty acid soaps, in particular zinc and/or potassium fatty acid soaps.

The rubber additives of the present invention can preferably be present in a blend which contains one or more solid carrier materials and one or more fatty acid esters as well as, where appropriate, further constituents. Inorganic fillers (such as for example silicas) or wax-like materials (such as for example polyethylene waxes) can preferably be used as carrier material.

In a preferred variant, a silica is used as carrier material. Examples of commercially available silicas which can be used in the blend of the present invention are Sipernat 22 and Sipernat 50 from Evonik.

In the blend, e.g. amides, amino alcohols and soaps can be used as further constituents. Several fatty acid esters according to the invention can also be present in a blend.

The weight ratio of carrier material to fatty acid ester in the blend is for example from 10/90 to 90/10, more preferably from 20/80 to 80/20 and particularly preferably approximately 30/70 or 33/67.

The use of a blend in particular makes it easier to handle the fatty acid esters, if they are liquid at room temperature.

### Rubber

The rubber composition according to the invention contains at least one rubber.

In a preferred embodiment, the rubber is a rubber that can be crosslinked by means of sulfur crosslinking. According to the invention, rubbers are used which are suitable in particular for the production of tread compounds which can be used in the production of tyres.

Preferred rubbers are diene rubbers. Rubbers which are formed by polymerization or copolymerization of dienes and/or cycloalkenes and thus have C═C double bonds either in the main chain or in the side groups are referred to as diene rubbers. Preferred diene rubbers are butadiene rubber, polyisoprene and styrene-butadiene rubber.

In a preferred embodiment, the rubber composition comprises at least one styrene-butadiene rubber, natural rubber, polyisoprene and/or butadiene rubber as well as, where appropriate, the functionalized forms thereof.

In a preferred embodiment, the rubber composition contains at least one styrene-butadiene rubber (styrene-butadiene copolymer). This can be both solution-polymerized styrene-butadiene rubber (SSBR) and emulsion-polymerized styrene-butadiene rubber (ESBR), wherein a mixture of at least one SSBR and at least one ESBR can also be used. The terms “styrene-butadiene rubber” and “styrene-butadiene copolymer” are used synonymously in the context of the present invention. The styrene-butadiene copolymer(s) used can be end-group-modified with modifications and functionalizations and/or functionalized along the polymer chains. The modification can be one with hydroxy groups and/or ethoxy groups and/or epoxy groups and/or siloxane groups and/or amino groups and/or aminosiloxane and/or carboxy groups and/or phthalocyanine groups and/or silane sulfide groups. However, further modifications known to a person skilled in the art, also referred to as functionalizations, also come into consideration. Metal atoms can be a constituent of such functionalizations.

The butadiene rubber (═BR, polybutadiene) can be all types known to a person skilled in the art. These include, among other things, the so-called high cis and low cis types, wherein polybutadiene with a cis content greater than or equal to 90 wt.-% is referred to as a high cis type and polybutadiene with a cis content of less than 90 wt.-% is referred to as a low cis type. A low cis polybutadiene is e.g. Li-BR (lithium-catalyzed butadiene rubber) with a cis content of from 20 to 50 wt.-%.

The polybutadiene used can be end-group-modified and/or functionalized along the polymer chains. Regarding this, reference may be made to the above possibilities disclosed in connection with the modification and functionalization of styrene-butadiene rubber, where appropriate adapted to the requirements of BR as rubber material.

According to a preferred embodiment, the rubber composition contains at least one styrene-butadiene rubber, preferably in quantities of from 40 to 100 phr, particularly preferably from 70 to 90 phr.

Furthermore, oil-extended rubber can also be added to the rubber compositions according to the invention. With respect to the quantities of oil-extended rubber used, it is usual also to “weigh out” the oil content, such that formulations with “rubber” quantities of above 100 phr, such as e.g. up to 200 phr, e.g. in the range of from 40 or 70 to 140 or 150 phr, can thereby result. As the oil content is usually known, however, oil-extended rubber can be added such that the sum of the solid rubber components (cf. the above definition) is such that a total of 100 parts by weight of rubber are present.

In an embodiment, the rubber additive is used in order to reduce the quantity of oil in oil-extended rubber. In this case, less oil is used in the rubber composition according to the invention than would be the case in a rubber composition with oil-extended rubber without the rubber additive.

According to a preferred embodiment, the rubber composition contains at least one styrene-butadiene rubber, which is functionalized with at least one of the above-named groups at the polymer chain ends and/or along the polymer chains (back bone functionalized). The functional groups are particularly preferably those groups which can bind to silica, such as in particular hydroxy groups and/or ethoxy groups and/or epoxy groups and/or siloxane groups and/or aminosiloxane and/or carboxy groups and/or silane sulfide groups.

According to a preferred embodiment, the rubber composition contains from 5 to 95 phr, preferably from 10 to 30 phr, of at least one butadiene rubber.

The rubber composition according to the invention can also contain natural and/or synthetic polyisoprene. Here, both cis-1,4-polyisoprene and 3,4-polyisoprene can be used. The rubber composition preferably contains cis-1,4-polyisoprenes with a cis-1,4 content of more than 90 wt.-%. Natural rubber is a rubber with a high cis-1,4 content. The polyisoprene used can also be end-group-modified and/or functionalized along the polymer chains. Regarding this, reference may be made to the above possibilities disclosed in connection with the modification and functionalization of styrene-butadiene rubber, where appropriate adapted to the requirements of polyisoprene as rubber material.

The named rubbers can also be contained in the rubber composition in combination with one another.

In a preferred embodiment, the rubber composition comprises at least one styrene-butadiene rubber and at least one butadiene rubber, in particular from 5 to 95 phr butadiene rubber and from 5 to 80 phr styrene-butadiene rubber.

In a further preferred embodiment, the rubber composition comprises at least one styrene-butadiene rubber, at least one butadiene rubber and at least one natural rubber, in particular from 5 to 80 phr butadiene rubber, from 5 to 80 phr styrene-butadiene rubber and from 5 to 60 phr natural rubber.

In a preferred embodiment, the rubber composition comprises at least one liquid polymer (viscous liquids at normal temperature) such as for example LIR (liquid polyisoprene), LBR (liquid polybutadiene) and L-SBR (liquid styrene-butadiene).

Kurapren LIR30 and Kurapren LIR50 from Kuraray Co., Ltd. can for example be used as liquid polyisoprene. LBR-302, LBR-307, LBR-305, LBR-352 or LBR-361 from Kuraray Co., Ltd. can for example be used as liquid polybutadiene. L-SBR-820 or L-SBR-841 from Kuraray Co., Ltd. can for example be used as liquid styrene-butadiene.

The rubber composition according to the invention can additionally contain further rubbers in comparatively small quantities, such as from 0.1 to 50 phr.

### Further Additives

The rubber composition of the present invention can contain further additives and constituents, in particular one or more fillers, one or more catalysts or activators for a sulfur crosslinking and, where appropriate, further additives.

In a preferred embodiment, the rubber composition of the present invention contains further additives and constituents which are suitable for the production of tread compounds for tyres.

The rubber composition preferably contains at least one filler. The rubber composition can contain from 5 to 300 phr, preferably from 30 to 300 phr, in particular from 50 to 200 phr, of at least one filler, wherein the total quantity of all fillers contained is meant.

According to a preferred embodiment of the invention, the total filler content is from 30 to 150 phr, particularly preferably from 60 to 140 phr, again preferably from 80 to 130 phr, again particularly preferably from 100 to 130 phr and again quite particularly preferably from 110 to 130 phr.

These can be all fillers known to a person skilled in the art, such as carbon black, carbon nanotubes, silica, aluminosilicates, phyllosilicates such as kaolin, calcium carbonate (chalk), starch, calcium carbonate, barium sulfate, magnesium oxides, aluminium oxides, titanium dioxide, or rubber gels.

The rubber composition preferably contains at least one silica as filler. The silicas can be the silicas known to a person skilled in the art, which are suitable as filler for rubber compositions. However, it is particularly preferred if a finely distributed, precipitated silica is used, which has a nitrogen surface area (BET surface area) (according to DIN ISO 9277) of from 35 to 350 m²/g, preferably from 35 to 260 m²/g, particularly preferably from 100 to 260 m²/g and quite particularly preferably from 115 to 235 m²/g, and a CTAB surface area (according to ASTM D 3765) of from 30 to 400 m²/g, preferably from 30 to 250 m²/g, particularly preferably from 80 to 250 m²/g and quite particularly preferably from 80 to 230 m²/g.

As silicas, e.g. both those of the type Ultrasil® 7000 GR (trade name) from Evonik, as well as Ultrasil® VN3 (trade name) from Evonik, and highly dispersible silicas, so-called HD silicas (e.g. Zeosil® 1165 MP from Solvay), can thus be used.

To improve the processability and to bind the silica and other possibly present polar fillers to the rubber, silane coupling agents can be used in the rubber composition. Here, one or more different silane coupling agents can be used in combination with one another. The rubber composition can thus contain a mixture of different silanes. The silane coupling agents react with the silanol groups on the surface of the silica or other polar groups during mixing of the rubber or the rubber composition (in situ) or already before the addition of the filler to the rubber in the sense of a pre-treatment (pre-modification). All silane coupling agents known to a person skilled in the art for use in the rubber composition can be used here as silane coupling agents. Such coupling agents known from the state of the art are bifunctional organosilanes, which have at least one alkoxy, cycloalkoxy or phenoxy group as leaving group on the silicon atom and which have, as other functionality, a group which can undergo a chemical reaction with the double bonds of the polymer, where appropriate after splitting.

It is furthermore advantageous if the rubber composition according to the invention contains at least one plasticizer, wherein the total quantity of plasticizer is preferably from 5 to 150 phr. The plasticizers used in the context of the present invention include all plasticizers known to a person skilled in the art such as aromatic, naphthenic or paraffinic mineral oil plasticizers, such as e.g. MES (mild extraction solvate) or RAE (residual aromatic extract) or TDAE (treated distillate aromatic extract), or rubber-to-liquid (RTL) oils or biomass-to-liquid (BTL) oils preferably with a polycyclic aromatic compound content of less than 3 wt.-% according to method IP 346, or factices, or plasticizer resins or natural oils (sunflower oil, rapeseed oil). The rubber composition can contain from 5 to 40 phr, preferably from 10 to 30 phr, plasticizer.

In an embodiment, the rubber additive is used in order to reduce the quantity of plasticizer in the rubber composition or to replace a plasticizer. In this case, less plasticizer is used in the rubber composition according to the invention than would be the case in a rubber composition without the rubber additive. This can be advantageous in certain cases, e.g. for environmental protection or economic reasons.

The rubber composition preferably furthermore contains substances required for the crosslinking such as zinc oxide, accelerators and/or sulfur.

It is in particular advantageous if the rubber composition according to the invention contains zinc oxide or zinc-containing compounds for the activation of the sulfur vulcanization. The vulcanization of the rubber composition may possibly be carried out in the presence of sulfur and/or sulfur donors and with the aid of vulcanization accelerators, wherein some vulcanization accelerators can at the same time act as sulfur donors, and sulfur and/or sulfur donors as well as vulcanization accelerators are used in the quantities known in the state of the art. Sulfur and/or sulfur donors as well as one or more accelerators are added to the rubber composition in the named quantities in the final mixing step. The accelerator is selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators. The use of at least one sulfenamide accelerator which is selected from the group consisting of N-cyclohexyl-2-benzothiazolesulfenamide (CBS) and/or N,N-dicyclohexylbenzothiazole-2-sulfenamide (DCBS) and/or benzothiazyl-2-sulfene morpholide (MBS) and/or 2,2′-dibenzothiazyl disulfide (MBTS) and/or N-tert-butyl-2-benzothiazylsulfenamide (TBBS) is preferred.

Several accelerators can also be used. A sulfenamide accelerator, particularly preferably CBS, in combination with the guanidine accelerator DPG (1,3-diphenylguanidine) is preferably used. The quantity of DPG is from 0 to 5 phr, preferably from 0.1 to 3 phr, particularly preferably from 0.5 to 2.5 phr, quite particularly preferably from 1 to 2.5 phr.

In addition, the rubber composition can contain usual additives in usual parts by weight. The additives can be selected from the list consisting of anti-ageing agents, activators, waxes, resins, mastication aids and processing aids and mixtures thereof.

N-Phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD) and 2,2,4-trimethyl-1,2-dihydroquinoline (TMQ) can for example be used as anti-ageing agents. The rubber composition according to the invention preferably comprises from 0.1 to 3 phr anti-ageing agents.

Zinc oxide and fatty acids (e.g. stearic acid) or zinc complexes such as e.g. zinc ethylhexanoate can for example be used as activators. The rubber composition according to the invention preferably comprises from 0.5 to 10 phr, preferably from 2 to 5 phr, activators. The rubber composition according to the invention preferably comprises from 0.1 to 3 phr waxes.

Plasticizer resins, such as e.g. C₅ petroleum resin, C₉ petroleum resin, terpene resin, coumarone-indene resin or a hydrocarbon resin consisting of alpha-methylstyrene and styrene (AMS resin), can in particular be used as resins. The rubber composition according to the invention preferably comprises from 5 to 150 phr, preferably from 15 to 50 phr, resins. 2,2′-Dibenzamidodiphenyl disulfide (DBD) can for example be used as mastication aids. The rubber composition according to the invention preferably comprises from 0.1 to 3 phr mastication aids.

Fatty acid salts, such as e.g. zinc soaps, can for example be used as processing aids. The rubber composition according to the invention preferably comprises from 0.5 to 10 phr, preferably from 2 to 5 phr, processing aids.

In particular, the rubber composition contains
a) from 0.1 to 3 phr anti-ageing agents,
b) from 0.5 to 10 phr, preferably from 2 to 5 phr, activators,
c) from 0.1 to 3 phr waxes,
d) from 5 to 100 phr, preferably from 15 to 50 phr, resins,
e) from 0.1 to 3 phr mastication aids, and
f) from 0.5 to 10 phr, preferably from 2 to 5 phr, processing aids.

The proportion of further additives in the total quantity is from 3 to 150 phr, preferably from 3 to 100 phr and particularly preferably from 5 to 80 phr.

### Composition

The rubber composition preferably contains between 0.1 and 40 phr fatty acid ester, such as from 1 to 40, from 2 to 40, from 3 to 40, from 4 to 40 or from 5 to 40.

In a preferred embodiment, the rubber composition contains from 1 to 30 phr, such as from 2 to 30, from 3 to 30, from 4 to 30, and in particular from 5 to 30 phr, fatty acid ester.

For this, the fatty acid esters according to the invention can on the one hand be metered into an existing rubber composition (in addition to other plasticizers) in a so-called “on top” use. In such a case, usage concentrations of between 0.5 and 5 phr are preferred. The fatty acid esters according to the invention can also be used in order to completely or at least partially replace other plasticizers. In such a case, much higher usage concentrations are advantageous, in particular from 5 to 40 or from 5 to 30 phr.

In a preferred embodiment, after vulcanization the composition has an at least 5%, preferably 10%, in particular 15%, lower rolling resistance, tan delta at 60° C., and/or a 5%, preferably 10%, in particular 15%, higher wet grip, tan delta at 0° C.

Furthermore, the composition preferably has an improved processability, in particular an at least 5%, preferably 10%, in particular 15%, lower Mooney viscosity and/or a correspondingly lower material pressure during extrusion.

Furthermore, the composition preferably has an improved stiffness, in particular an at least 5%, preferably 10%, in particular 15%, higher tear strength and/or elongation at break and/or tensile strength at modulus 100% and/or tensile strength at modulus 300%.

The above-named improvements (lower rolling resistance, higher wet grip, improved processability, increased stiffness) can be determined in comparison with an otherwise identical composition which, instead of the additive according to the invention, comprises an identical quantity of a rubber additive known from the state of the art. For testing, two otherwise identical rubber compositions are produced, and their properties are then compared with each other.

The above-named improvements (lower rolling resistance, higher wet grip, improved processability, increased stiffness) can furthermore be determined in comparison with an otherwise identical composition which, instead of the additive according to the invention, comprises an identical quantity of a plasticizer known from the state of the art. Commercially available materials, such as for example Tudalen 4192, can be used as known plasticizers. For testing, two otherwise identical rubber compositions are produced, and their properties are then compared with each other.

The above-named improvements can also be determined in comparison with an otherwise identical composition which does not contain the rubber additive according to the invention. For testing, in this case two identical rubber compositions are produced and the rubber additive according to the invention is additionally added to one of them. The properties of the two rubber compositions are then compared with each other.

The rubber composition is preferably suitable for the production of tread compounds for tyres. The rubber composition according to the invention is furthermore also suitable for treads which consist of different tread compounds arranged next to one another and/or one underneath the other (multicomponent treads).

### Production

The rubber additive defined above is generally produced by simply mixing the components. This is effected until a desired homogeneous mixture is achieved. Suitable mixing devices are known to persons skilled in the art.

The production of the rubber composition according to the invention is effected in a conventional manner, wherein as a rule a basic mixture which contains all constituents with the exception of the vulcanization system (sulfur and vulcanization-influencing substances) is produced first of all in one or more mixing steps and the finished mixture is subsequently produced by adding the vulcanization system.

The composition can then be further processed, e.g. through an extrusion process, and be brought into the corresponding form, e.g. the form of a tread blank.

The general process for producing rubber compositions and vulcanizates thereof is described in “Rubber Technology Handbook”, W. Hofmann, Hanser Verlag 1994. It is known to a person skilled in the art that, where appropriate depending on the mixture, in particular depending on the filler content, further mixing steps are to be carried out after the first basic mixing step in order to achieve a better lowering of the viscosity and a better homogenization.

### Tyres

The present invention also relates to a tyre in which at least one component part was at least partially produced from a rubber composition according to the invention. The tyre is preferably an all-season or winter tyre.

In the context of the present invention, by tyres is meant pneumatic vehicle tyres and solid rubber tyres, including tyres for industrial and construction site vehicles, HGV, car and two-wheel tyres.

According to a preferred embodiment of the invention, the tyre has the rubber composition according to the invention at least in the tread.

The present invention furthermore relates to a process for producing a tyre, wherein one or more component parts of the tyre are produced from the rubber composition according to the invention and the rubber composition is cured.

The use of the rubber composition according to the invention can significantly improve the process for producing tyres and treads.

### Use

The present invention furthermore relates to the use of fatty acid esters of at least one C₈ to C₂₂ fatty acid and a compound selected from C₂ to C₄ alkoxylate of a polyol, polyethylene glycol, polypropylene glycol and/or copolymer of ethylene oxide and propylene oxide as rubber additive in a rubber composition for improving the Mooney viscosity and/or extrusion properties of the rubber composition and/or for improving at least one out of wear, wet grip and/or rolling resistance of a tyre produced from the rubber composition.

In a preferred embodiment of the use according to the invention, at least one of the named properties is improved compared with a rubber composition which, instead of the rubber additive according to the invention, comprises an identical quantity of a known rubber additive. Materials known in the state of the art which are used as rubber additives can be used as known rubber additives. For testing, two otherwise identical rubber compositions are produced, and their properties are then compared with each other.

In a preferred embodiment, at least one of the named properties is improved by at least 5%, preferably at least 10%, compared with a rubber composition which, instead of the rubber additive according to the invention, comprises an identical quantity of a known rubber additive.

In a preferred embodiment, at least one of the named properties is improved by at least 5%, preferably at least 10%, compared with an otherwise identical rubber composition, i.e. the rubber additive according to the invention is additionally added to the rubber composition. For testing, in this case two identical rubber compositions are produced and the rubber additive according to the invention is additionally added to one of them. The properties of the two rubber compositions are then compared with each other.

In a preferred embodiment, at least one of the named properties is improved by at least 5%, preferably at least 10%, compared with a rubber composition which, instead of the rubber additive according to the invention, comprises an identical quantity of a known plasticizer and is otherwise identical. Commercially available materials, such as for example Tudalen 4192, can be used as known plasticizer.

In a preferred embodiment, the extrusion properties of the rubber composition are improved compared with a rubber composition which, instead of the rubber additive according to the invention, comprises an identical quantity of a known plasticizer or comprises no plasticizer and is otherwise identical. By the extrusion properties is meant properties such as the extrusion speed, die swell, extrusion rate, material pressure, material temperature and/or the surface/edge condition of the extrudate.

In a preferred embodiment, the surface condition and/or edge condition of the extrudate is improved. Here, the surface is evaluated using a grading system of A-E, wherein A represents the best grade. The edges are evaluated using a grading system of 1-10, wherein 10 represents the best grade (in each case according to ASTM D 2230).

The rubber additive according to the invention can be used in particular in a rubber composition for treads.

In a preferred embodiment, in the case of the use according to the invention a blend is used which contains
a) one or more solid carrier materials, and
b) one or more fatty acid esters, as well as
c) where appropriate further constituents such as amides, amino alcohols and/or soaps.

Inorganic fillers (such as for example silicas) or wax-like materials (such as for example polyethylene waxes) can preferably be used as carrier material. In a preferred embodiment, a silica is used as carrier material.

The weight ratio of carrier material to fatty acid ester in the blend is for example from 10/90 to 90/10, more preferably from 20/80 to 80/20 and particularly preferably approximately 30/70 or 33/67.

### EXAMPLES

The invention will now be explained in more detail with reference to comparison and embodiment examples, but without being limited to these examples.

### Example 1—Production of the Rubber Additives According to the Invention

### a) Rubber Additive A

1217.8 g ethoxylated glycerol (Aduxol GLY-07 from Schärer+Schläpfer), 835.7 g fatty acid and 2.0 g hypophosphorous acid were provided. An oleic acid mixture which contains 72.5% C_{18:1}, 8% C_{18:2}, 6% C_{16:1}, 4.5% C₁₆, 4% C_{14+14:1}, ≤4% C₁₄, ≤3% C₁₈, ≤2.5% C_{18:3} and ≤1% C₁₂ was used as fatty acid. The oleic acid mixture had an acid value of 201.0 mg KOH/g, a saponification value of 202.0 mg KOH/g and an iodine value of 100.0 g iodine/100 g. The iodine value was determined according to DIN EN ISO 3961 2018-11 and the saponification value according to DIN EN ISO 3681.

The mixture was slowly heated to 230° C. and a vacuum was applied. The reaction progress was monitored by measuring the acid value. The fatty acid ester produced had an acid value of 4.6 mg KOH/g. From the measurement of the hydroxyl value it was possible to deduce that predominantly a monoester was obtained.

### b) Rubber Additive B

592.2 g polyethylene glycol 400, 408.7 g fatty acid and 1.0 g hypophosphorous acid were provided. Distilled soybean oil fatty acid which contains 2-6% Cis, 20-29% C_{18:1}, 47-58% C_{18:2}, 4-10% C_{18:3}, 9-12% C₁₆, 0-1% C_{16:1}, and 0-1% C₁₂₊₁₄ was used as fatty acid. The soybean oil fatty acid used had an acid value of from 194 to 204 mg KOH/g, a saponification value of 195-206 mg KOH/g and an iodine value of 125-139 g iodine/100 g.

The mixture was slowly heated to 230° C. and a vacuum was applied. The reaction progress was monitored by measuring the acid value. The fatty acid ester produced had an acid value of 1.9 mg KOH/g. The kinematic viscosity at 20° C. of the fatty acid ester produced was 95.1 mm²/sec and the dynamic viscosity at 20° C. was 94.8 mPa-s.

### c) Rubber Additive C

352.8 g polypropylene glycol 600, 161.8 g soybean oil fatty acid (see rubber additive B) and 0.5 g hypophosphorous acid were provided.

The mixture was slowly heated to 230° C. and a vacuum was applied. The reaction progress was monitored by measuring the acid value. The fatty acid ester produced had an acid value of 1.7 mg KOH/g. The kinematic viscosity at 20° C. of the fatty acid ester produced was 107.1 mm²/sec.

### Example 2—Production of a Rubber Composition According to the Invention

The mixture was produced under usual conditions in one or more mixing steps. It was then further processed, e.g. through an extrusion process, and brought into the corresponding form.

The different components of the individual mixtures are indicated in the tables given below.

TABLE 1

| Component | Chemical class | Properties |
|---|---|---|
| Sprintan SLR 3402 | Styrene-butadiene rubber | Glass transition temperature −62° C. |
| Buna CB 24 | Butadiene rubber | Neodymium BR, Mooney viscosity |
| | | 44 MU, cis-1,4 content = 96% |
| Natural Rubber SVR 10 | Natural rubber | |
| Ultrasil 7000 GR | Silica | CTAB surface area = 160 m2/g |
| Zeosil 1165 MP | Silica | CTAB surface area = 160 m²/g, |
| | | micropearls |
| Struktol SCA 985 | Bis(triethoxysilylpropyl) disulfide | Silane |
| Struktol SCA 98 CB | Bis[3-(triethoxysilyl)propyl] | Silane + carbon black (50%) |
| | tetrasulfide/carbon black | |
| Luvomaxx BC N-330 | Carbon black | Iodine adsorption value: 82 ± 5 [g/kg] |
| Tudalen 4192 | Processing oil | Plasticizer |
| Sylvatraxx 4202 | Resin | Softening point 115° C. |
| Varazon 5998 | Wax | Antiozonant |
| ZnO Harzsiegel GR | Zinc oxide | Activator |
| 6PPD | N-(1,3-Dimethylbutyl)-N′- | Anti-ageing agent |
| | phenyl-1,4-benzenediamine | |
| TMQ | 2,2,4-Trimethyl-1,2- | Anti-ageing agent |
| | dihydroquinoline | |
| TBBS | N-tert-Butyl-2-benzothiazyl | Accelerator |
| | sulfenamide | |
| CBS | N-Cyclohexyl-2-benzothiazole | Accelerator |
| | sulfenamide | |
| DPG | 1,3-Diphenylguanidine | Accelerator |

In all of the mixture examples contained in the table, the quantities indicated (parts by weight) are based on 100 parts by weight total rubber (phr).

Test pieces were produced from all mixtures and material properties typical for the rubber industry were ascertained with these test pieces using the test methods indicated in the following:
Mooney viscosity (MS 1+4, 100° C.), after each mixing step and after ageing, in each case according to DIN EN ISO 289-1,
Extrusion properties (extrusion speed, die swell, extrusion rate, material pressure, material temperature) surface evaluation (Garvey die: surface A-E with A as best grade, edges 1-10 with 10 as best grade), in each case according to ASTM D 2230,
Material pressure at different shear rates was measured using a Göttfert high pressure capillary Rheograph 25 (measuring temperature 100° C., nozzle geometry: round, length 10 mm, diameter 1 mm).
Rebound resilience at RT, measured according to ASTM D-8059
Shore A hardness at room temperature (RT), measured according to DIN EN ISO 868,
Tear strength, elongation at break and tensile strength measured according to DIN 53 504, parameters for stiffness, also for tyre wear,
Stress values at 100 and 300% elongation at room temperature (modulus 100%, modulus 300%), according to DIN 53 504,
Loss factor tan delta at −20° C., 0° C. and 60° C. according to DIN 53 545,
   Dynamic mechanical analysis, wherein the vulcanized material is clamped and dynamically loaded,
   Grip on snow can be correlated with the tan delta at −20° C. (the larger the tan delta at −20° C., the better the snow grip), as described in the Encyclopedia of Polymer Blends, Volume 2: Processing, edited by Avraam I. Isayev, Sanjay Palsule,
   Wet grip can be correlated with the tan delta at 0° C. (the larger the tan delta at 0° C., the better the wet grip),
   Rolling resistance can be correlated with the tan delta at 60° C. (the smaller the tan delta at 60° C., the lower the rolling resistance),
Rebound according to DIN 53512.

### Example 3—Comparison with Processing Oil

In this example, the properties of a rubber composition which contains the additive A produced in Example 1 (composition B) were compared with the properties of an otherwise identical rubber composition which contains only TDAE oil (composition A). The comparison shows improved processing properties as well as an improved tyre handling and comparable tyre grip properties of the rubber composition B according to the invention. Moreover, the rubber composition according to the invention in particular has a lower rolling resistance, tan delta at 60° C.

The corresponding information and data are shown in the following Table 2.

TABLE 2

| Composition | A | B |
|---|---|---|
| Sprintan SLR 3402 | 80 | 80 |
| Buna CB 24 | 20 | 20 |
| Ultrasil 7000 GR | 100 | 100 |
| Struktol SCA 985 | 8 | 8 |
| Luvomaxx BC N-330 | 8 | 8 |
| Tudalen 4192 (TDAE oil) | 30 | 15 |
| ZnO Harzsiegel GR | 2.5 | 2.5 |
| Varazon 5998 | 1.5 | 1.5 |
| Stearic acid | 1 | 1 |
| Richon 6PPD | 2 | 2 |
| Sulfur | 1.4 | 1.4 |
| Double Vigour CBS-G | 1.7 | 1.7 |
| Double Vigour DPG-C | 2 | 2 |
| Additive A | | 15 |

Processability

| | | |
|---|---|---|
| Mooney ML (1 + 4) 100° C. [MU] | 116 | 101 |
| Mooney 24 h/RT | 65 | 57 |
| Mooney 1 week/RT | 71 | 60 |

after 24 h

| | | |
|---|---|---|
| Garvey die, 15 min⁻¹ material pressure [bar] | 66 | 56 |
| Edge/surface evaluation at 15 min⁻¹ | 5C | 9A |
| Extrudate swell at 60 min⁻¹ [g/m] | 88.6 | 89.1 |
| Garvey die, 60 rpm/min material pressure [bar] | 77 | 71 |
| Edge/surface evaluation at 60 min⁻¹ | 3C | 7B |

after 1 week

| | | |
|---|---|---|
| Material pressure at 15 min⁻¹ [bar] | 70 | 63 |
| Edge/surface evaluation at 15 min⁻¹ (Garvey die) | 2D | 6B |
| Material pressure at 60 min⁻¹ [bar] | 94 | 90.7 |
| Extrudate swell at 60 min⁻¹ [g/m] | 81 | 76 |
| Edge/surface evaluation at 60 min⁻¹ (Garvey die) | 2D | 4C |

Tyre wear, handling

| | | |
|---|---|---|
| Tear strength [MPa] | 21.4 | 22 |
| Elongation at break [%] | 432 | 431 |
| Tear propagation strength [kN/m] | 15.5 | 24.1 |
| Wear loss [cmm] | 45 | 52 |
| Stress value 100% [MPa] | 2.7 | 3.1 |
| Stress value 300% [MPa] | 12.6 | 13.8 |

Snow grip

| | | |
|---|---|---|
| tan delta at −20° C. | 0.476 | 0.472 |

Wet grip

| | | |
|---|---|---|
| tan delta at 0° C. | 0.361 | 0.355 |

Rolling resistance

| | | |
|---|---|---|
| tan delta at 60° C. | 0.189 | 0.164 |

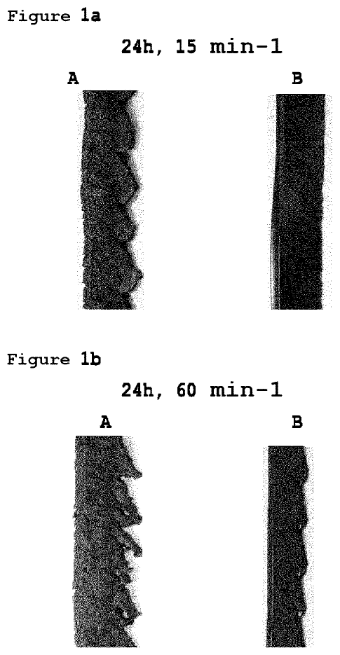

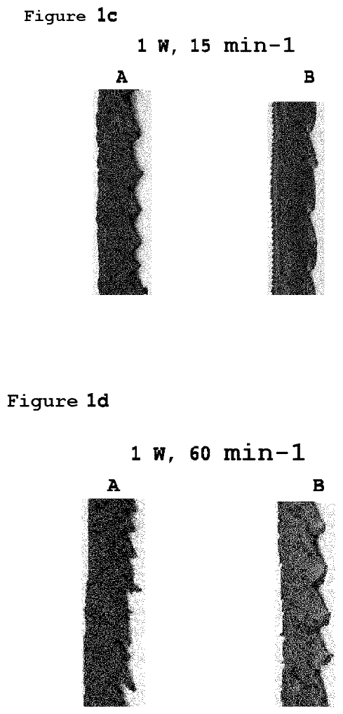

Images of different extrudates of compositions A and B (after 24 h and after one week, at 60 min⁻¹ and 15 min⁻¹) are represented in FIGS. 1a-d. Here, FIG. 1a shows extrudates of compositions A and B after 24 h at 15 min⁻¹, FIG. 1b shows extrudates of compositions A and B after 24 h at 60 min⁻¹, FIG. 1c shows extrudates of compositions A and B after one week at 15 min⁻¹ and Figure id shows extrudates of compositions A and B after one week at 60 min⁻¹.

As illustrated, the extrudates of the rubber composition B according to the invention have far fewer edges and an improved surface structure in all cases. Moreover, the rubber composition B according to the invention has a better processability (lower Mooney viscosity) and an improved rolling resistance (lower tan delta at 60° C.).

### Example 4—Comparison with Composition without Rubber Additive According to the Invention

This example compares the properties of a rubber composition having additive A from Example 1 (composition D) with an otherwise identical rubber composition without the additive (composition C).

TABLE 3

| Composition | C | D |
|---|---|---|
| Sprintan SLR 3402 | 50.00 | 50.00 |
| Buna CB 24 | 40.00 | 40.00 |
| Natural Rubber SVR 10 | 10.00 | 10.00 |
| Zeosil 1165 MP | 130.00 | 130.00 |
| Struktol SCA 98 CB | 20.00 | 20.00 |
| Tudalen 4192 (TDAE oil) | 40.00 | 40.00 |
| Sylvatraxx 4202 | 25.00 | 25.00 |
| Richon 6PPD | 2.00 | 2.00 |
| Khimprom TMQ | 0.50 | 0.50 |
| Varazon 5998 | 1.50 | 1.50 |
| ZnO Harzsiegel GR | 2.50 | 2.50 |
| Stearic acid | 1.00 | 1.00 |
| Sulfur | 1.40 | 1.40 |
| Double Vigour TBBS-G | 1.80 | 1.80 |
| Double Vigour DPG-C | 2.20 | 2.20 |
| Additive A | | 5.00 |

Processability

| | | |
|---|---|---|
| 1st mixing step: Mooney MS [1 + 4] 100° C. [MU] | 133 | 121 |
| 2nd mixing step: Mooney MS [1 + 4] 100° C. [MU] | 86 | 80 |

after 24 h

| | | |
|---|---|---|
| Material pressure at 15 min⁻¹ [bar] | 49 | 44 |
| Edge/surface evaluation at 15 min⁻¹ (Garvey die) | 4C | 4B |
| Material pressure at 60 min⁻¹ [bar] | 62 | 57 |
| Extrudate swell at 60 min⁻¹ [g/m] | 88.8 | 89.2 |
| Edge/surface evaluation at 60 min⁻¹ (Garvey die) | 4C | 4B |

Tyre wear, handling

| | | |
|---|---|---|
| Tear strength [MPa] | 15.2 | 17.2 |
| Elongation at break [%] | 372 | 417 |
| Tear propagation strength [kN/m] | 16.5 | 20.6 |
| Wear loss [cmm] | 81 | 71 |
| Stress value 100% [MPa] | 2.7 | 2.9 |
| Stress value 300% [MPa] | 11.4 | 11.6 |

Snow grip

| | | |
|---|---|---|
| tan delta at −20° C. | 0.567 | 0.575 |

Wet grip

| | | |
|---|---|---|
| tan delta at 0° C. | 0.442 | 0.467 |

Rolling resistance

| | | |
|---|---|---|
| tan delta at 60° C. | 0.233 | 0.239 |

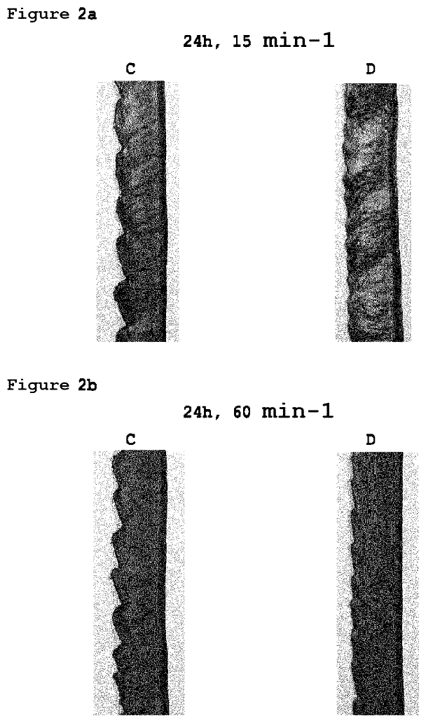

Images of different extrudates of compositions C and D after 24 h at 60 min⁻¹ and 15 min⁻¹ are represented in FIGS. 2a and b. Here, FIG. 2a shows extrudates at 15 min⁻¹ and FIG. 2b shows extrudates at 60 min-.

As illustrated, the extrudates of the rubber composition D according to the invention have an improved surface structure in both cases. Moreover, the rubber composition D according to the invention has a better processability (lower Mooney viscosity), an improved tyre handling (higher stiffness), better wear properties (improved ultimate tear properties and lower DIN wear values) and an improved wet grip (higher tan delta at 0° C.) with a comparable rolling resistance (tan delta at 60° C.).

### Example 5—Comparison with Glycerol Monooleate

In this example, the properties of a rubber composition which contains the additive A produced in Example 1 (composition E) were compared with the properties of an otherwise identical rubber composition which contains glycerol monooleate instead (composition F).

The comparison shows improved processing properties as well as an improved tyre handling and comparable to improved tyre grip properties of the rubber composition E according to the invention. Moreover, the rubber composition according to the invention has in particular a lower rolling resistance, tan delta at 60° C.

The corresponding information and data are shown in the following Table 4.

| Composition | E | F |
|---|---|---|
| Sprintan SLR 3402 | 80.00 | 80.00 |
| Buna CB 24 | 20.00 | 20.00 |
| Ultrasil 7000 GR | 100.00 | 100.00 |
| Struktol SCA 985 | 8.00 | 8.00 |
| N-330 Corax | 8.00 | 8.00 |
| Tudalen 4192 (TDAE oil) | 15.00 | 15.00 |
| Additive A | 15.00 | |
| Glycerol monooleate | | 15.00 |
| PEG 400 monooleate | | |
| ZnO Harzsiegel GR | 2.50 | 2.50 |
| Varazon 5998 | 1.50 | 1.50 |
| Stearic acid | 1.00 | 1.00 |
| Richon 6PPD | 2.00 | 2.00 |
| Sulfur | 1.40 | 1.40 |
| Double Vigour CBS-G | 1.70 | 1.70 |
| Double Vigour DPG-C | 2.00 | 2.00 |

Processability

| | | |
|---|---|---|
| 1st mixing step: Mooney MS [1 + 4] 100° C. [MU] | 68 | 58 |
| 2nd mixing step: Mooney MS [1 + 4] 100° C. [MU] | 50 | 48 |
| 1 week/RT | 54 | 53 |

after 24 h

| | | |
|---|---|---|
| Material pressure at 15 min⁻¹ [bar] | 42 | 45 |
| Edge/surface evaluation at 15 min⁻¹ (Garvey die) | 8A | 4A |
| Extrudate swell at 60 min⁻¹ [g/m] | 103.9 | 113.5 |
| Material pressure at 60 min⁻¹ [bar] | 57 | 59 |
| Edge/surface evaluation at 60 min⁻¹ (Garvey die) | 6B | 4B |

after 1 week

| | | |
|---|---|---|
| Material pressure at 15 min⁻¹ [bar] | 50 | 56 |
| Edge/surface evaluation at 15 min⁻¹ (Garvey die) | 4B | 4C |
| Extrudate swell at 60 min⁻¹ [g/m] | 96.1 | 93.1 |
| Material pressure at 60 min⁻¹ [bar] | 75 | 74 |
| Edge/surface evaluation at 60 min⁻¹ (Garvey die) | 4C | 3C |

Tyre wear, handling

| | | |
|---|---|---|
| Tear strength [MPa] | 20.6 | 21.8 |
| Elongation at break [%] | 404 | 483 |
| Tear propagation strength [kN/m] | 17.1 | 27.5 |
| Wear loss [cmm] | 44 | 34 |
| Stress value 100% [MPa] | 3.2 | 2.4 |
| Stress value 300% [MPa] | 14.4 | 11.2 |

Snow grip

| | | |
|---|---|---|
| tan delta at −20° C. | 0.456 | 0.427 |

Wet grip

| | | |
|---|---|---|
| tan delta at 0° C. | 0.330 | 0.314 |

Rolling resistance

| | | |
|---|---|---|
| tan delta at 60° C. | 0.145 | 0.172 |

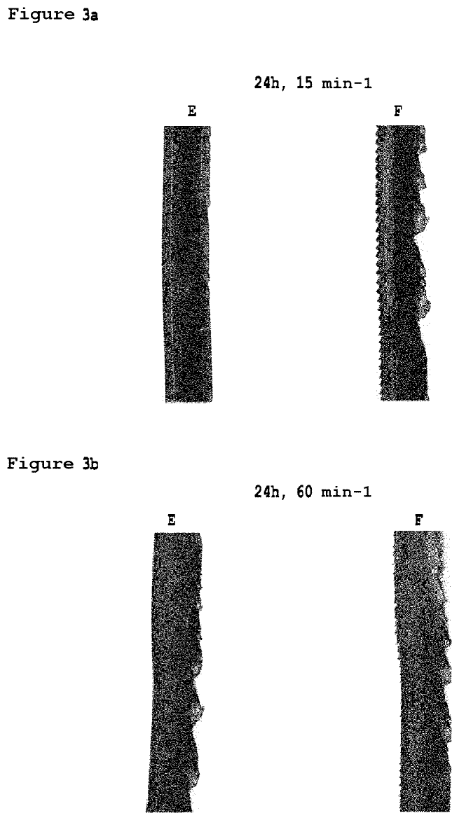

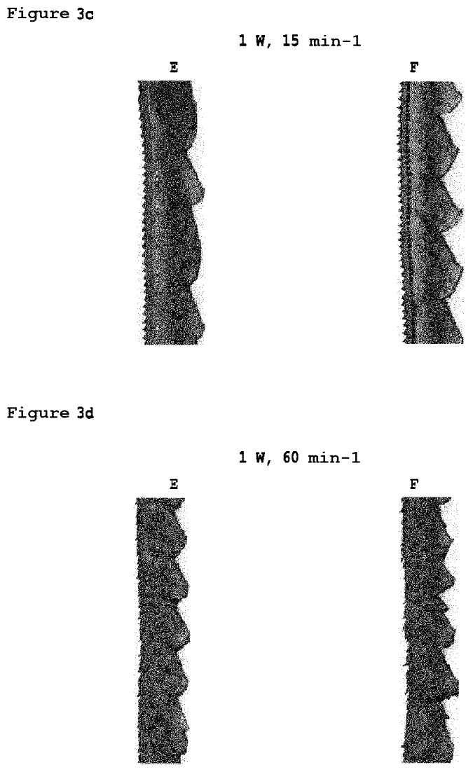

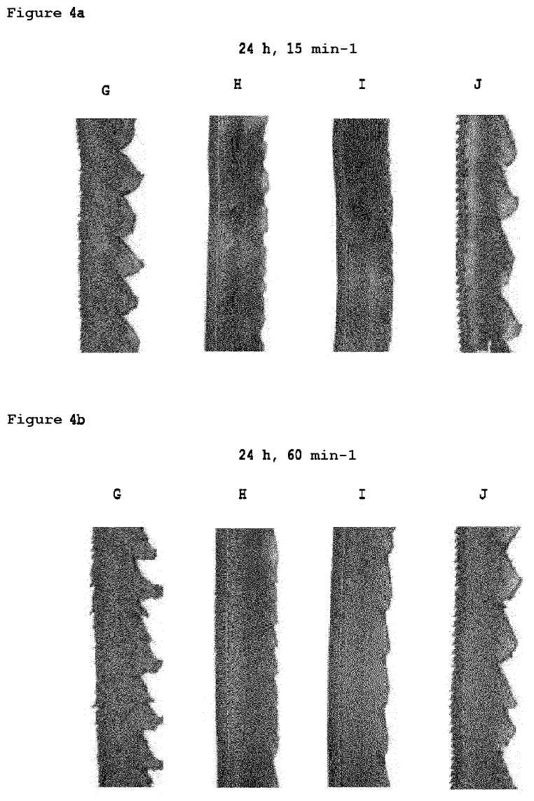

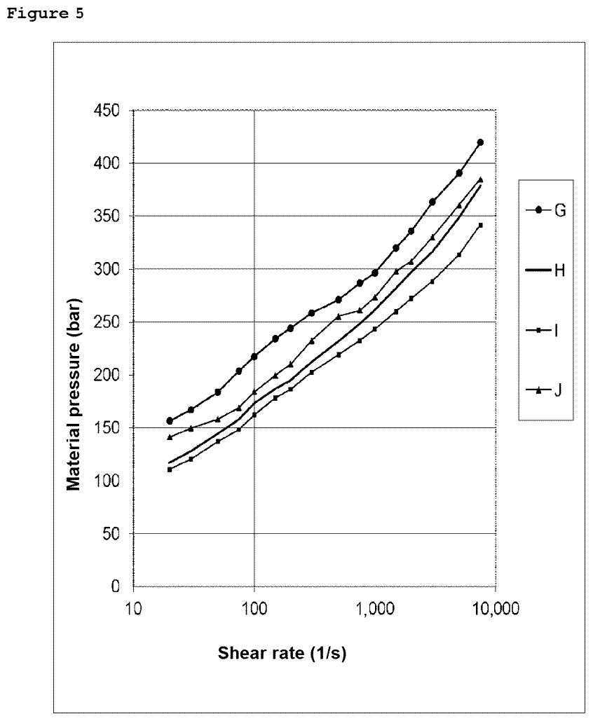

Images of different extrudates of compositions E and F (after 24 h and after one week, at 60 min⁻¹ and 15 min⁻¹ are represented in FIGS. 3a-d. Here, FIG. 3a shows extrudates of compositions E and F after 24 h at 15 min⁻¹, FIG. 3b shows extrudates of compositions E and F after 24 h at 60 min⁻¹, FIG. 3c shows extrudates of compositions E and F after one week at 15 min⁻¹ and FIG. 3d shows extrudates of compositions E and F after one week at 60 min⁻¹. As can be seen from FIGS. 3a-d, the extrudates of the rubber composition B according to the invention have far fewer edges and an improved surface structure in all cases. Moreover, the rubber composition E according to the invention has an improved tyre handling (higher stiffness), an improved snow grip (higher tan delta at −20° C.), an improved wet grip (higher tan delta at 0° C.) as well as an improved rolling resistance (lower tan delta at 60° C.).

### Example 6—Comparison of Properties of Rubber Additives A-C

In this example, the properties of rubber compositions which contain the additives A to C produced in Example 1 (composition H-J) were compared with the properties of an otherwise identical rubber composition which contains more TDAE processing oil instead (composition G).

The comparison (see the data in Table 5) shows improved processing properties. Depending on the additive used, the processing can be improved in a targeted manner in different process steps (for example during mixing or extruding). In addition, further material properties can also be optimized in a goal-oriented manner through the choice of the additive.

TABLE 5

| Composition | G | H | I | J |
|---|---|---|---|---|
| Sprintan SLR 3402 | 80.00 | 80.00 | 80.00 | 80.00 |
| Buna CB 24 | 20.00 | 20.00 | 20.00 | 20.00 |
| Ultrasil 7000 GR | 100.00 | 100.00 | 100.00 | 100.00 |
| Struktol SCA 985 | 8.00 | 8.00 | 8.00 | 8.00 |
| Luvomaxx BC N-330 | 8.00 | 8.00 | 8.00 | 8.00 |
| Tudalen 4192 (TDAE oil) | 40.00 | 20.00 | 20.00 | 20.00 |
| Additive A | | 20.00 | | |
| Additive B | | | 20.00 | |
| Additive C | | | | 20.00 |
| ZnO Harzsiegel GR | 2.50 | 2.50 | 2.50 | 2.50 |
| Varazon 5998 | 1.50 | 1.50 | 1.50 | 1.50 |
| Stearic acid | 1.00 | 1.00 | 1.00 | 1.00 |
| Richon 6PPD | 2.00 | 2.00 | 2.00 | 2.00 |
| Sulfur | 1.40 | 1.40 | 1.40 | 1.40 |
| Double Vigour CBS-G | 1.70 | 1.70 | 1.70 | 1.70 |
| Double Vigour DPG-C | 2.00 | 2.00 | 2.00 | 2.00 |

Processability

| | | | | |
|---|---|---|---|---|
| 1st mixing step: Mooney MS [1 + 4] 100° C. [MU] | 71 | 49 | 59 | 49 |
| 2nd mixing step: Mooney MS [1 + 4] 100° C. [MU] | 56 | 40 | 41 | 45 |
| 2nd mixing step: Mooney MS [1 + 4] 100° C. [MU] | 68 | 47 | 44 | 54 |
| after 2 weeks | | | | |

after 24 h

| | | | | |
|---|---|---|---|---|
| Material pressure at 15 min⁻¹ [bar] | 50 | 31 | 32 | 38 |
| Edge/surface evaluation at 15 min⁻¹ (Garvey die) | 4C | 5A | 6A | 4A |
| Material pressure at 60 min⁻¹ [bar] | 64 | 47 | 47 | 53 |
| Edge/surface evaluation at 60 min⁻¹ (Garvey die) | 3C | 5A | 6A | 4B |

Tyre wear, handling

| | | | | |
|---|---|---|---|---|
| Tear strength [MPa] | 19.7 | 19.4 | 19.9 | 21.7 |
| Elongation at break [%] | 449 | 476 | 489 | 540 |
| Tear propagation strength [kN/m] | 12 | 22.7 | 24.4 | 24.5 |
| Wear loss [cmm] | 32 | 36 | 33 | 30 |
| Stress value 100% [MPa] | 2.3 | 2.6 | 2.6 | 2.2 |
| Stress value 300% [MPa] | 10.7 | 10.9 | 11 | 9.7 |

Wet grip

| | | | | |
|---|---|---|---|---|
| Rebound RT | 46 | 44 | 44 | 42 |
| tan delta at 0° C. | 0.332 | 0.349 | 0.337 | 0.347 |

Rolling resistance

| | | | | |
|---|---|---|---|---|
| tan delta at 60° C. | 0.165 | 0.169 | 0.167 | 0.193 |

Grip at high temperatures

| | | | | |
|---|---|---|---|---|
| tan delta at 20° C. | 0.249 | 0.269 | 0.256 | 0.276 |

In general, the compositions H-J according to the invention have improved extrusion properties (lower material pressure, improved extrudates) and lower mix viscosities.

Additive C (composition J) has, in addition to the improved processing (lower Mooney MS values and material pressures), better ultimate tear properties (tear strength, elongation at break and tear propagation strength) as an indicator of better C&C (cut & chip) properties and higher tan delta values at 0° C. and 20° C. as an indicator of better tyre grip in wet and dry conditions.

Additive B (composition I) shows an even clearer improvement in the processability, visible through lower material pressures specifically at high shear rates, with at the same time improved tear propagation strength, without having a negative effect on the conflicting goals of wet braking (comparable tan delta at 0° C.)—rolling resistance (comparable tan delta at 60° C.).

1. A rubber composition, which contains rubber and at least one rubber additive, characterized in that the at least one rubber additive comprises fatty acid ester, which fatty acid ester is produced from at least one C₈ to C₂₂ fatty acid and at least one compound selected from C₂ to C₄ alkoxylate of a polyol, polyethylene glycol, polypropylene glycol and/or copolymer of ethylene oxide and propylene oxide.

2. The rubber composition according to claim 1, characterized in that the fatty acid comprises at least one saturated or unsaturated C₁₂ to C₂₂ fatty acid.

3. The rubber composition according to claim 1, characterized in that the fatty acid ester is produced from at least one polyethylene glycol, polypropylene glycol and/or statistical copolymer or block copolymer of ethylene oxide and propylene oxide.

4. The rubber composition according to claim 1, characterized in that the fatty acid ester is produced from at least one polyol ethoxylate with up to 10 ethylene oxide units (EO units) and/or polyol propoxylate with up to 10 propylene oxide units (PO units).

5. The rubber composition according to claim 4, characterized in that the polyol ethoxylate is ethoxylated glycerol, which has up to 10 ethylene oxide units (EO units).

6. The rubber composition according to claim 1, characterized in that the fatty acid ester has:
an acid value (AV) of from 0 to 10 mg KOH/g; and/or
a hydroxyl value (HV) of from 5 to 190 mg KOH/g; and/or
a setting point of from 5 to −50° C.; and/or
a dynamic viscosity of 50-1000 mPa-s.

7. The rubber composition according to claim 1, characterized in that the composition contains between 0.1 to 40 phr fatty acid ester.

8. The rubber composition according to claim 1, characterized in that the composition comprises at least one styrene-butadiene rubber, polyisoprene rubber, natural rubber and/or butadiene rubber as well as, where appropriate, the functionalized forms thereof.

9. The rubber composition according to claim 1, characterized in that the composition has an at least 5% lower Mooney viscosity and/or an at least 5% lower material pressure during extrusion compared with an identical composition which, instead of the rubber additive according to the invention, comprises an identical quantity of a known rubber additive.

10. The rubber composition according to claim 1, characterized in that after vulcanization the composition has an at least 5% lower rolling resistance, tan delta at 60° C., and/or a 5% higher wet grip, tan delta at 0° C., compared with an identical composition which, instead of the rubber additive according to the invention, comprises an identical quantity of a known rubber additive.

11. The rubber composition according to claim 1, characterized in that the composition is suitable for the production of tread compounds for tyres.

12. A method of use of fatty acid esters of at least one C₈ to C₂₂ fatty acid and at least one compound selected from C₂ to C₄ alkoxylate of a polyol, polyethylene glycol, polypropylene glycol and/or copolymer of ethylene oxide and propylene oxide as rubber additive in a rubber composition for improving the Mooney viscosity and/or the extrusion properties of the rubber composition and/or for improving at least one out of wear, wet grip and/or rolling resistance of a tyre produced from the rubber composition.

13. The method Use according to claim 12, wherein at least one of the named properties is improved by at least 5% compared with a rubber composition which, instead of the rubber additive according to the invention, comprises an identical quantity of a known rubber additive.

14. The method according to claim 12, characterized in that the rubber composition contains between 0.1 to 40 phr fatty acid ester.

15. The method according to claim 12, characterized in that a blend is used which contains
a) one or more solid carrier material(s),
b) one or more of the fatty acid esters as well as
c) where appropriate further constituents.

16. A process for producing a tyre, characterized in that one or more component parts of the tyre are produced from a rubber composition according to claim 1 and the rubber composition is cured.

17. A tyre, in which at least one component part was produced at least partially from a rubber composition according to claim 1.
